(19) United States
(12) Patent Application Publication
(10) Pub. No.: US 2010/0224602 A1
(43) Pub. Date: Sep. 9, 2010

(54) METHOD AND SYSTEM FOR REMOVING THERMAL BARRIER COATING

(75) Inventors: David A. Helmick, Fountain Inn, SC (US); David L. Burin, Greer, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/399,212

(22) Filed: Mar. 6, 2009

(51) Int. Cl. B23K 26/00

(52) U.S. Cl. 219/121.66; 219/121.85; 219/121.65; 219/121.6

(57) ABSTRACT

A method and system for removing a thermal barrier coating on a turbine component is provided. The method includes the steps of selecting at least one turbine component having a thermal barrier coating, and subjecting at least a portion of the thermal barrier coating to a shockwave. The shockwave forms cracks in the thermal barrier coating, such that the substrate of the turbine component is not substantially deformed.

### BACKGROUND OF THE INVENTION

This invention generally relates to a method for removing protective coatings from metal alloy components, and more particularly, to a method for removing a thermal barrier coating (TBC) from turbine components.

The operating conditions to which gas or steam turbine hardware components are exposed may be thermally and chemically severe. The surfaces of the metal substrates used to form turbine, combustor and augmentor components should exhibit greater than average mechanical strength, durability and erosion resistance in a very hostile, high temperature gas environment. “Erosion” generally refers to the process whereby a surface, particularly metal, is bombarded by contaminant particles of sufficiently high energy that cause other particles to be ejected (eroded) from the surface, resulting in degradation and cracking of the substrate material.

Recent advances have been achieved by using high temperature alloys in gas or steam turbine systems by incorporating iron, nickel and cobalt-based superalloys in coatings applied to the substrate of key turbine components. The purpose of an effective surface coating is generally two-fold. First, the coating should form a protective and adherent layer that guards the underlying base material against oxidation, corrosion, and degradation. Second, the coating should have low thermoconductivity relative to the substrate. As superalloy compositions have become more complex, it has been increasingly difficult to obtain both the higher strength levels that are required (particularly at increased turbine operating temperatures) and a satisfactory level of corrosion and oxidation resistance. The trend towards higher turbine firing temperatures has made the oxidation, corrosion and degradation problems even more difficult. Thus, despite recent improvements in thermal barrier coatings, many alloy components have difficulty withstanding the long service exposures and repetitive cycles encountered in a typical gas or steam turbine environment.

Many of the known prior art coatings used for gas or steam turbine components include aluminide and ceramic components. Typically, ceramic coatings have been used in conjunction with a bond coating formed from an oxidation-resistant alloy such as MCrAlY, where M is iron, cobalt, and/or nickel, or from a diffusion aluminide or platinum aluminide that forms an oxidation-resistant intermetallic. In higher temperature applications, these bond coatings form an oxide layer or “scale” that chemically bonds to the ceramic layer to form the final bond coating.

It has also been known to use zirconia (ZrO₂) that is partially or fully stabilized by yttria (Y₂O₃), magnesia (MgO) or other oxides as the primary constituent of the ceramic layer. Yttria-stabilized zirconia (YSZ) is often used as the ceramic layer for thermal bond coatings because it may exhibit favorable thermal cycle fatigue properties. That is, as the temperature increases or decreases during turbine start up and shut down, the YSZ is capable of resisting stresses and fatigue much better than other known coatings. Typically, the YSZ is deposited on the metal substrate using known methods, such as air plasma spraying (APS), low pressure plasma spraying (LPPS), as well as by physical vapor deposition (PVD) techniques such as electron beam physical vapor deposition (EBPVD). Notably, YSZ deposited by EBPVD is characterized by a strain-tolerant columnar grain structure that enables the substrate to expand and contract without causing damaging stresses that lead to spallation.

Over the lifetime of a turbine, the thermal barrier coatings may need to be removed and/or re-applied. Some known methods for TBC removal include manual or automated blasting with an abrasive material (e.g., sand). High-pressure water jets have also been used to remove the thermal barrier coatings. However, all of these known methods are costly and labor intensive.

### BRIEF DESCRIPTION OF THE INVENTION

In an aspect of the present invention, a method for removing a coating on a component is provided. The method includes the steps of selecting at least one component having a coating, and subjecting at least a portion of the coating to a shockwave. The shockwave forms cracks in the coating, such that the substrate of the component is not substantially deformed.

In another aspect of the present invention, a method for removing a thermal barrier coating on a turbine component is provided. The method includes the steps of selecting at least one turbine component having a thermal barrier coating, and subjecting at least a portion of the thermal barrier coating to a shockwave. The shockwave forms cracks in the thermal barrier coating, such that the substrate of the turbine component is not substantially deformed. At least a portion of the thermal barrier coating is removed from said turbine component.

In yet another aspect of the present invention, a system for removing a thermal barrier coating on a turbine component is provided. At least one component has a thermal barrier coating, and the component is a blade, nozzle, bucket, shroud or airfoil. Means for subjecting at least a portion of the thermal barrier coating to a shockwave are provided, such that cracks are formed in the thermal barrier coating. The substrate of the component is not substantially deformed. At least a portion of the thermal barrier coating is removed from the component.

### BRIEF DESCRIPTION OF THE DRAWINGS

FIG. 1 is a cross-sectional view of a metal substrate, such as a high pressure gas turbine blade, showing the thermal barrier coating as applied to the blade using a laser shock process in accordance with an embodiment of the invention.

FIG. 2 schematically illustrates the amount of energy required to induce cracks in a thermal barrier coating.

### DETAILED DESCRIPTION OF THE INVENTION

As noted above, thermal barrier coatings according to the present invention are applicable to various metal alloy components (so-called “superalloys”) that must still be protected from a thermally and chemically hostile environment. Examples of such components include blades, nozzles, buckets, shrouds, airfoils, and other hardware found in gas or steam turbines.

The coating may be any known TBC composition, e.g., it may consist of titanium nitride or a thermal insulating ceramic layer whose composition and deposition significantly enhance the erosion resistance of the turbine components while maintaining a spallation resistance equivalent to or better than conventional coatings. Alternatively, the TBC coating could be any material or alloy suitable for use in reducing erosion and/or corrosion in turbine components.

High pressure turbine blades are prime examples of the substrates to which coatings in accordance with the invention can be removed. Typically, turbine blades have an airfoil and a platform against which hot combustion gases are directed during operation of the gas turbine. Thus the airfoil surfaces are subjected to attack by oxidation, corrosion, and erosion. The airfoil normally is anchored to a turbine disk with a dovetail formed on a root section of the blade.

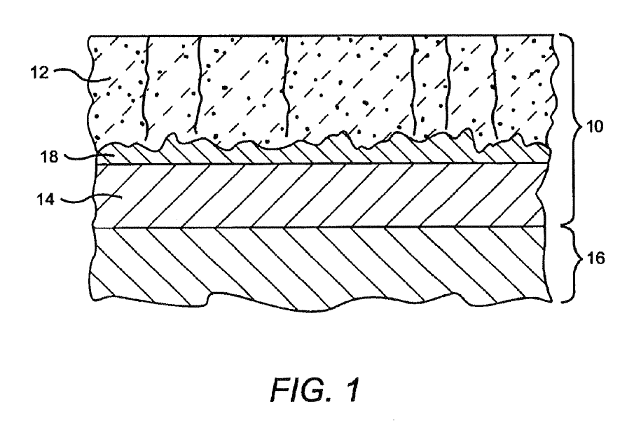

FIG. 1 shows a thermal barrier coating as applied to a substrate. The coating 10 includes a thermal-insulating ceramic layer 12 over a bond coating 14 that overlies a metal alloy substrate 16 which may form the base material of the turbine blade. Suitable materials or alloys for the substrate include iron-, nickel-, steel-, and/or cobalt-based superalloys. The bond coating 14 may be oxidation resistant and may form an alumina layer 18 on the surface of the bond coating when the coated blade is exposed to elevated temperatures. The alumina layer 18 may protect the underlying superalloy substrate 16 from oxidation and may provide a surface to which the ceramic layer 12 adheres.

Within layer 12, there may be vertical cracks that have been formed so as to increase and/or induce strain tolerance. Crack induction via shockwave exposure may enable the cracks to be placed in the material in particularly desirable areas and at specifically desirable densities. To form the cracks, coupled ablation may be used to induce a shockwave into a material. The coupled ablation may be achieved through the use of a pulsed laser in a process similar to laser shock peening, where a laser is pulsed thorough the coupling material and into the ablative material thus creating a shockwave.

In the case of a TBC, though, the resultant shockwave can induce microcracks within the coating to provide strain tolerance. Other means of shockwave exposure may be possible (e.g., ultrasonic, etc.). Other means of coupled ablation may also be possible.

In an exemplary embodiment, the TBC 10 may be removed from substrate 16 by using laser induced shockwaves. The energy used to induce the removal of the TBC should preferably not substantially deform the substrate. Thus, the energy should be chosen appropriately because the coating may be very thin. In order to substantially deform the substrate, the energy of the shock wave would need to be sufficient to impart stress at or above the plastic yield of the substrate but below its compressive strength. In contrast thereto, the energy used to remove the TBC should be sufficient to impart stress above compressive strength of the TBC. Because the metallic substrate may be ductile, and the ceramic TBC may be brittle, there may be a particular level of energy that can be selected or determined

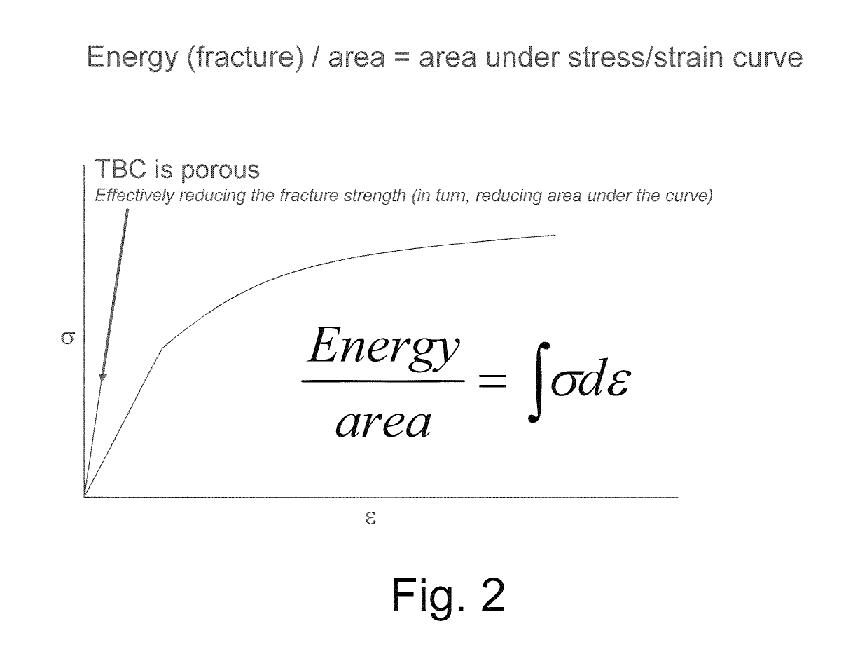

FIG. 2 schematically illustrates a general description of the amount of energy required to remove a TBC. The amount of energy (per unit area) to fracture a material is represented by the area under the stress/strain curve. FIG. 2 illustrates a typical porous TBC coating. The porosity reduces the “effective” cross-sectional area and therefore reducing the force required for fracture (because energy is a function of force not pressure or stress). This may effectively reduce the area under the curve considerably.

In preferred embodiments, a thermal barrier coating experiences a shockwave (e.g., via laser ablation or ultrasonic application) and is fractured. The fracturing induces cracks in the TBC 10, and leads to the spallation or removal of the coating. The energy that may be required may depend on the source of the shockwave, e.g., laser ablation, ultrasonic or other, and/or the properties of material being removed.

Laser induced spallation, according to aspects of the present invention, can be employed to remove the TBC 10 in a cost effective manner. A high energy pulsed laser (e.g., Nd:YAG) can be used to create a compressive stress pulse in the TBC 10 wherein it propagates and reflects off as a tensile wave at the free boundary. This tensile pulse spalls/peels the TBC 10 while propagating towards the substrate 16. The stress pulse created in this fashion can be around 3-8 nanoseconds in duration while its magnitude varies as a function of laser fluence. Due to the non-contact application of load, this technique is very well suited to spall TBC coatings.

Thus, in certain embodiments of the present invention, a process (e.g., laser ablation, laser shock peening or ultrasonic application) may produce microstructural cracks, and can be used for the removal of TBC coatings.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for removing a coating on a component, the method comprising the steps of:
selecting at least one component having a coating;
subjecting at least a portion of the coating to a shockwave such that cracks are formed in the coating and such that a substrate of said component is not substantially deformed.

2. The method of claim 1, wherein the coating is a thermal barrier coating and wherein the component is a turbine component.

3. The method of claim 2, the turbine component comprising at least one of:
a blade, nozzle, bucket, shroud, and airfoil.

4. The method of claim 2, the turbine comprising a gas turbine or a steam turbine.

5. The method of claim 2, the thermal barrier coating comprising a metal alloy or ceramic material.

6. The method of claim 2, the step of subjecting at least a portion of the thermal barrier coating to a shockwave further comprising at least one of:
laser ablation, laser shock peening, laser induced spallation and ultrasonic application.

7. The method of claim 2, wherein the step of subjecting at least a portion of the thermal barrier coating to a shockwave does not include subjecting the entire thermal barrier coating to the shockwave.

8. The method of claim 2, wherein the substrate comprises a superalloy comprising at least one of steel, iron, nickel, or cobalt.

9. The method of claim 2, further comprising the step of:
removing at least a portion of said thermal barrier coating from said turbine component.

10. A method for removing a thermal barrier coating on a turbine component, the method comprising the steps of:
selecting at least one turbine component having a thermal barrier coating;
subjecting at least a portion of the thermal barrier coating to a shockwave such that cracks are formed in the thermal barrier coating and such that a substrate of said turbine component is not substantially deformed; and
removing at least a portion of said thermal barrier coating from said turbine component.

11. The method of claim 10, the turbine component comprising at least one of:
a blade, nozzle, bucket, shroud, and airfoil.

12. The method of claim 10, the turbine comprising a gas turbine or a steam turbine.

13. The method of claim 10, the thermal barrier coating comprising a metal alloy or ceramic material.

14. The method of claim 10, the step of subjecting at least a portion of the thermal barrier coating to a shockwave further comprising at least one of:
laser ablation, laser shock peening, laser induced spallation and ultrasonic application.

15. The method of claim 10, wherein the step of subjecting at least a portion of the thermal barrier coating to a shockwave does not include subjecting the entire thermal barrier coating to the shockwave.

16. The method of claim 15, wherein the substrate comprises a superalloy comprising at least one of steel, iron, nickel, or cobalt.

17. A system for removing a thermal barrier coating on a turbine component, at least one component having a coating, said at least one component comprising at least one of a blade, a nozzle, a bucket, a shroud, and an airfoil, the system comprising:
means for subjecting at least a portion of the coating to a shockwave such that cracks are formed in the coating and such that a substrate of said at least one component is not substantially deformed; and
means for removing at least a portion of said coating from said at least one component.

18. The system of claim 17, the thermal barrier coating comprising a metal alloy or ceramic material.

19. The system of claim 17, the means for subjecting at least a portion of the coating to a shockwave further comprising at least one of:
laser ablation, laser shock peening, laser induced spallation and ultrasonic application.

20. The system of claim 17, the substrate comprising a superalloy comprising at least one of steel, iron, nickel, or cobalt.
